(19) United States
(12) Patent Application Publication
(10) Pub. No.: US 2026/0146926 A1
(43) Pub. Date: May 28, 2026

(54) APPARATUS AND A METHOD USING THE SAME FOR THE ISOLATION OF THE SINGLE CELL

(71) Applicants: HTI Technology Industries, Inc., La Vergne, TN (US); OneCell Diagnostics, Inc., Cupertino, CA (US)

(72) Inventors: David J. Goodin, Yerington, NV (US); Jayant Jagannath Khandare, Pune (IN); Mohan Uttarwar, Cupertino, CA (US)

(21) Appl. No.: 19/396,719

(22) Filed: Nov. 21, 2025

Related U.S. Application Data
(60) Provisional application No. 63/723,979, filed on Nov. 22, 2024.

(51) Int. Cl. G01N 1/40

(52) U.S. Cl. CPC G01N 1/4077

(57) ABSTRACT

Provided in this disclosure is an extraction device including a bell having a hollow interior cavity, to extend downwardly into a receptacle that receives and retains one or more beads. A probe is retained within the bell and configured for reciprocal motion to extend into and retract out of the receptacle. A head of the probe is connected to a stem of the probe such that a diameter of the head is greater than a diameter of the stem. A rim of the head circumferentially surrounds a junction with the stem and defining an interior surface of the head facing into the interior cavity of the bell. The probe extends into the receptacle to enable the beads to rest upon the rim. The probe retracts to withdraw the beads upward into the interior cavity of the bell, for extracting the bell and the beads from the receptacle.

### CROSS-REFERENCE TO RELATED APPLICATIONS

This non-provisional application claims priority to U.S. Provisional Patent Application Ser. No. 63/723,979, filed on Nov. 22, 2024.

### I. BACKGROUND

### A. Technical Field

This invention pertains to an apparatus for the isolation of a single cell from the blood of a cancer patient. More particularly it relates to an apparatus for the isolation of single circulating tumor cells from the blood samples of multiple number of cancer patients and a method for the isolation of single circulating tumor cells from the blood samples of multiple number of cancer patients using the same.

### B. Description of Related Art

Cancer is a genetic disorder that is difficult to treat because of tumor heterogeneity and continuous evolution of tumor biology due to the genomic instability of tumor cells. The technological advancements have helped identify how tumor-driving gene alterations dysregulate protein-protein interactions within human cells harbouring mutations. However, the data output from these platforms is significantly biased towards the population-based input. Isolation of individual live circulating tumor cells (CTCs) and performing multi-omics analysis thereon helps overcome these problems.

Many methods have been proposed for the isolation of circulating tumor cells (CTCs) in the prior art.

However, the cells captured by these technologies are not 100% CTCs. In most cases the CTCs captured are contaminated with white blood cells. Studying the CTCs individually will allow a greater understanding the heterogeneity of tumor biology. The methods developed so far, are limited by accuracy, speed, and throughput. Some isolation methods involve fixation, staining, or other steps which may affect the quality of cells limiting their utility in subsequent genomic analysis.

US 2014/0308669 A1 (2014) discloses methods for obtaining single cells from a sample of human blood. The CTC population obtained, contains at least 0.5 % non-CTCs. Cell picking techniques for isolating individual CTCs are also disclosed. A microinjection system is mounted on a micromanipulation system for cell picking. Alternatively, a micromanipulation system is mounted on a microscope stage for cell picking. Laser capture microdissection has also been deployed for cell picking. A robot for cell picking assisted by an integrated imaging camera is reported wherein a cell picking head comprising a hollow pin for aspirating a single cell to be picked from a microscope slide.

US 2015/0330880A1 (2015) discloses systems and methods for analysing a target analyte such as CTC in a suspension. The system comprises a tube, a float, and a cap, the cap further comprises a magnetic insert and a receiving piece.

U.S. Pat. No. 9,174,216 (2015) discloses a system and method for capturing and analysing cells. The system comprises a fluid delivery module; a reservoir to receive a biological sample including a target cell population and at least one fluid from the fluid delivery module; a manifold to receive and distribute the biological sample and at least one fluid from the reservoir into a cell capture device; a waste chamber configured to couple to the manifold; and a pump configured to couple to the waste chamber.

U.S. Pat. No. 9,612,199 (2017) discloses a system for imaging captured cells The system comprises an illumination module to illuminate a target object; a platform to position the target object in relation to the illumination module; a filter module configured to filter light transmitted to the target object and/or to filter light received from the target object, an optical sensor configured

to receive light from the target object and to generate image data; and a focusing and optics module configured to manipulate light transmitted to the optical sensor.

US 2018/0221869 A1 (2018) discloses a density-based fluid separation and method for retrieving target material from a suspension. The ratio of target to non-target material could be as low as 1 part target material, such as a single cell, protein, DNA etc to 30,000,000 parts non—target material. The system for effecting separation includes a processing vessel, a displacement fluid, and a tube.

U.S. Pat. No. 9,856,535 (2018) discloses a system and method for isolating cells. The system comprises 1) a substrate having a broad surface, 2) an array comprising a set of wells defined at the broad surface of the substrate, 3) an encapsulation module removably coupled to the substrate at an interface, 4) a fluid delivery module surrounding the array and fluidly coupled to each well in the set of wells 5) a perimeter channel directly fluidly coupled to the inlet and to each well of the exterior subset of the set of wells wherein the exterior subset of the set of wells positioned at an outermost edge of the array.

U.S. Pat. No. 11,504,714 (2022) discloses system and method for capturing and analysing cells within the cell sorting field. The system and the method generate a set of genetic complexes comprising the biomolecules associated with a single captured cell and a subset of probes within individual wells of the array of wells.

The Indian patent application number 202241064961 dated 12 Nov. 2022 titled “Compositions and methods for selective capture, purification, release and isolation of single cells” discloses compositions useful to isolate marker cells for cancer at the single-cell level from heterogeneous biological and clinical blood samples and method to capture and release intact circulating tumor cells (CTCs) and isolate the same as single cells from the blood samples of cancer patients. However, the same is not amenable to isolate single cells from a large population of cancer patients.

There is thus a need for a system and a method for isolating a single cell, more particularly a circulating tumor cell.

### II. SUMMARY

Provided in this disclosure is a bead picker which picks from 1 to 6 beads at a time from a receptacle and delivers the same number of beads that it picked up into another receptacle.

The present disclosure also describes an apparatus for the simultaneous selective isolation of individual single cells from blood samples of multiple number of cancer patients and a method for simultaneous selective isolation of individual single cells from blood samples of multiple number of cancer patients using the apparatus disclosed herein.

The present disclosure also discloses an apparatus for selective isolation of individual single cells comprising 1) a bead picker specifically designed for the purpose as disclosed above, 2) reservoir for the storage of glass beads, 3) well plates, 4) reservoir for the storage of medium containing a population of single cells 5) reservoir for the storage of phosphate buffer solution 6) reservoir for the storage of medium which releases the single cell linked to the glass bead into the well 7)incubators, 8) robotic arm for the movement of the well plate, 9) micro pipettor 10) assisted camera, 11) optionally a fluorescence microscope, and 12) optionally a micro-manipulator.

In an embodiment of the invention the bead picker specifically designed for the purpose picks up 1-6 glass beads from a receptacle.

In an embodiment of the invention the bead is made from a material selected from glass, plastic and metal.

In an embodiment of the invention the bead diameter is in the range 0.5 mm to 5 mm.

In an embodiment of the invention the bead picker transfers all the beads picked up in the previous step to a single well in the well plate.

In an embodiment of the invention the bead picker picks up at least one glass bead from one well in the well plate and transfer to another well in the well plate.

In an embodiment of the invention the micro pipettor can draw up to eight samples.

In an embodiment of the invention the micro pipettor is provided with disposable tips.

In an embodiment of the invention the micro pipettor is provided with reusable probes.

In an embodiment of the invention the micro pipettor is fitted onto a head that is capable of movement in the X-Y-Z directions.

In an embodiment of the invention the reservoir for the storage of glass beads stores 6-80 glass beads.

In an embodiment of the invention the reservoir for the storage of glass beads is made of a material selected from glass, plastic and metal

In an embodiment of the invention the bead picker is capable of movement in the X-Y-plane.

In an embodiment of the invention the bead picker is capable of movement in the X direction over a distance of 10 cm to 14 cm.

In an embodiment of the invention the bead picker is capable of movement in the Y direction over a distance of 4 cm to 8 cm.

In an embodiment of the invention the well plate is selected from a 96 well plate and a 48 well plate.

In an embodiment of the invention the well plate is transparent and allows passage of light.

In an embodiment of the invention the well plate is held on a platform that is capable of movement in the X-Y plane.

In an embodiment of the invention the number of samples that the micro pipettor can draw is in the range 1-8.

In an embodiment of the invention the reservoir for the storage of medium containing a population of single cells is a stand that holds 1-12 sampling tubes of 1.5 ml capacity spaced such that the micro pipettor can simultaneously draw the samples from all the tubes.

In an embodiment of the invention more than one bead picker can be simultaneously employed.

In an embodiment of the invention more than one micropipette holder can be simultaneously employed.

In an embodiment of the invention the reservoir for the storage of the phosphate buffer solution is a rectangular trough having a length of about 10 cm, width about 0.5 cm and depth of about 1 cm.

In an embodiment of the invention the reservoir for the storage of the phosphate buffer solution is made of a material selected from glass, plastic and metal.

In an embodiment of the invention the reservoir for the storage of the phosphate buffer solution, stores at least 5 ml phosphate buffer solution.

In an embodiment of the invention the reservoir for the storage of the release medium is a rectangular trough having a length of about 10 cm, width about 0.5 cm and depth of about 1 cm.

In an embodiment of the invention the reservoir for the storage of the release medium is made of a material selected from glass and plastic

In an embodiment of the invention the reservoir for the storage of the release medium is covered with a lid and has openings to accept micro pipettor.

The timing and movement of the bead picker, the micro pipettor and the platform holding the well plate are controlled by appropriate software programs.

Other benefits and advantages of this invention will become apparent to those skilled in the art to which it pertains upon reading and understanding of the following detailed specification.

### III. BRIEF DESCRIPTION OF THE DRAWINGS

The disclosed apparatus and method may take physical form in certain parts and arrangement of parts, embodiments of which will be described in detail in this specification and illustrated in the accompanying drawings which form a part hereof and wherein:
FIG. 1 is an exploded view of components of a bead picker in accordance with the present invention.

FIG. 2 is a side view of assembled components of a bead picker in accordance with the present invention.

FIG. 3 is a side sectional view of an outer bead picker in accordance with the present invention.

FIG. 4 is an exploded view of components of the bead picker including a housing in accordance with the present invention.

FIG. 5 is an assembled view of components of the bead picker including a housing in accordance with the present invention.

FIG. 6 is a perspective view showing the operation of the bead picker in accordance with the present invention.

FIG. 7 is a side view of the outer bead picker with the probe retracted in accordance with the present invention.

FIG. 8 is a side view of the outer bead picker with the probe extended in accordance with the present invention.

FIG. 9 is a perspective view of the outer bead picker with the probe extended in accordance with the present invention.

FIGS. 10A, 10B, and 10C are side sectional views of the bead picker in operation in accordance with the present invention.

### IV. DETAILED DESCRIPTION

Reference is now made to the drawings wherein the showings are for purposes of illustrating embodiments of the article only and not for purposes of limiting the same, and wherein like reference numerals are understood to refer to like components.

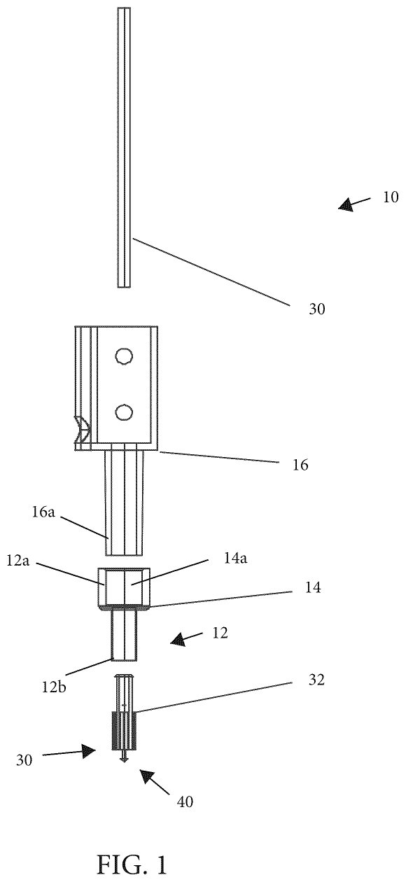

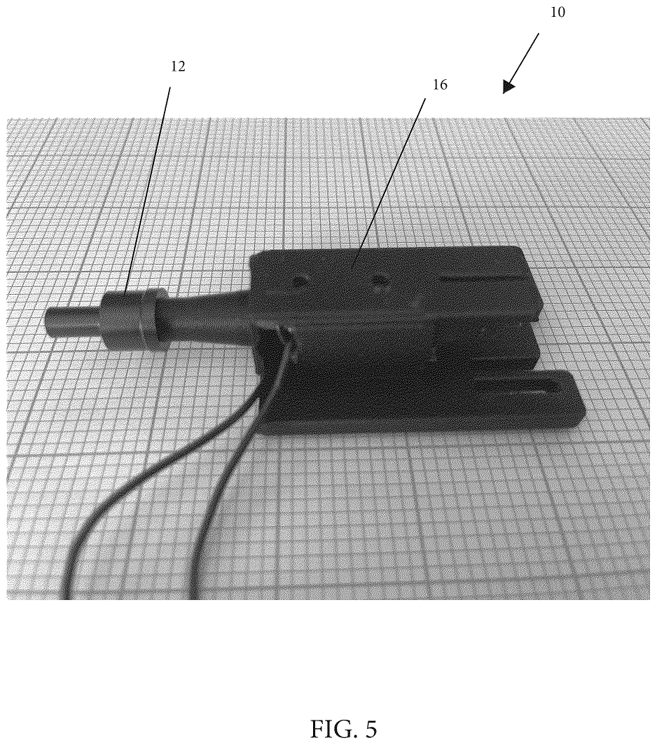

With specific reference to FIGS. 1, 5, and 6, a bead picker 10 is shown as an extraction device for removing beads from a well. However, it is to be understood that the present invention could be scaled in size to extract any sort of “beads” which are understood to be any spherical or other suitably shaped objects of any size that are received and retained in any suitable sort of receptacle, in accordance with the description herein.

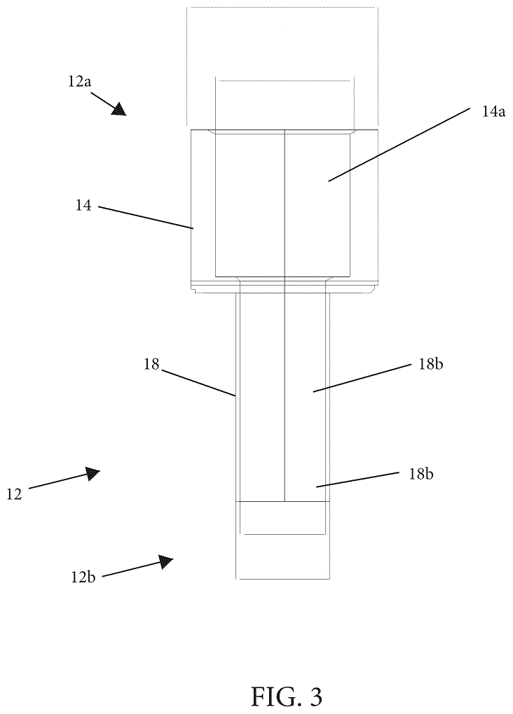

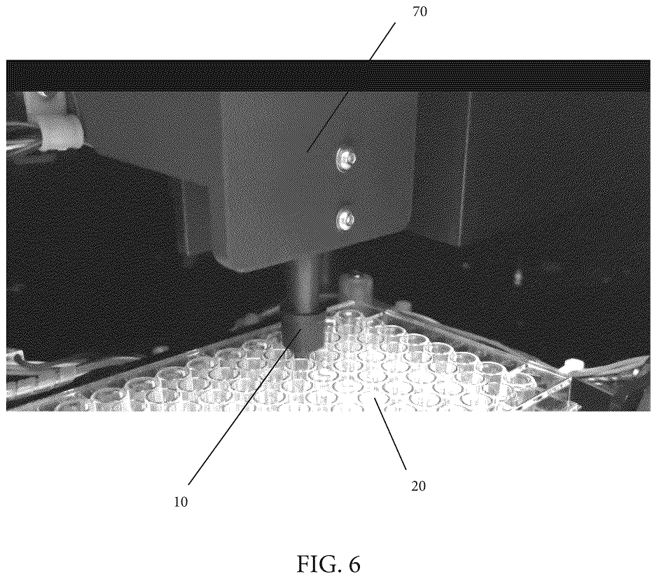

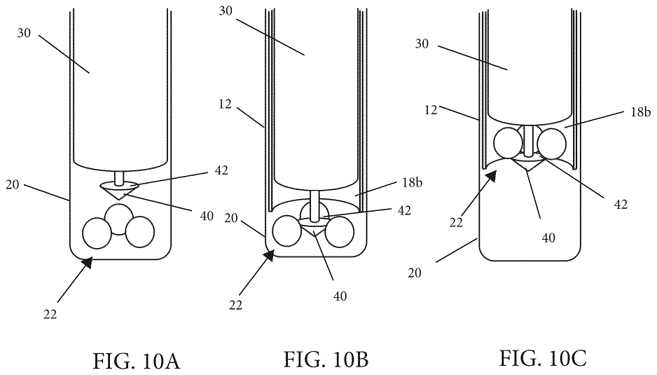

With ongoing specific reference to FIGS. 1, 3, 5, and 6, the bead picker 10 includes an outer bead picker tip 12 having a proximal end 12a located in a rearward portion, and a distal end 12b in a frontward portion, toward the operation of the device. A cap 14 is at the proximal end 12b of the outer bead picker tip 12 for connecting to a support housing 16. As best shown in FIG. 3, the cap 14 includes a cylindrical aperture 14a having an inner diameter sized to be matingly received over a cylindrical outer diameter 16a of the support housing 16. The outer bead picker tip 12 also includes a body 18 having a central bore 18a internally within the body 18. The distal end 12b of the body 18 defines a bell 18b. The central bore 18a includes a hollow cavity that defines the interior of the bell 18b. It is a “bell” insofar as it is a downwardly directed opening or cavity in a manner similar to an original “diving bell.” As shown in FIGS. 6, 10A, 10B, and 10C, the outer bead picker tip 12 is configured to extend the bell 18a downwardly into a well 20 or other such receptacle that receives and retains one or more beads 22. The outer diameter of the bell 18b is preferably generally cylindrical sized to be matingly received within the cylindrical inner diameter of the well 20.

With specific reference to FIGS. 1, 2, and 4, an inner bead picker tip 30 is retained within the central bore 18a of the outer bead picker tip. The inner bead picker tip 30 includes a middle portion 32 having a diameter sized to be matingly received within the inner diameter of the central bore 18a. In this manner the inner bead picker tip 30 is configured to freely slide back and forth with reciprocal movement within the central bore 18a. An upper portion 34 of the inner bead picker tip 30 has a narrower outer diameter than the middle portion 32 and is sized to be received within an inner diameter 16b of the housing 16. In this manner, the reciprocal movement of the inner bead picker tip 30 is restricted by the middle portion 32 which stops upon encountering the narrower inner diameter 16b of the support housing 16. The upper portion 34 also has an internal bore 34a having an inner diameter sized to engage with a connecting rod 30, which runs through the support housing 16, the outer bead picker tip 12 and into the upper portion of the inner bead picker tip 30 along a central axis 36. The connecting rod 36 is configured for the reciprocal movement to displace the inner bead picker tip 30 as described hereinbelow.

With reference to FIGS. 1, 2, 4,6, 8, 9, 10A, 10B, and 10C, the inner bead picker tip 30 includes a probe 40 retained within the bell 18b and configured for the reciprocal motion to extend into and retract out of the well 20. A head 42 of the probe 40 is connected to a stem 44 of the probe 40 in such a manner that a diameter of the head is greater than a diameter of the stem 44. A rim 46 of the head 42 circumferentially surrounds a junction of the head 42 and stem 44. The rim 46 defines an interior surface of the head 42 that faces upwards into the interior cavity of the bell 28b.

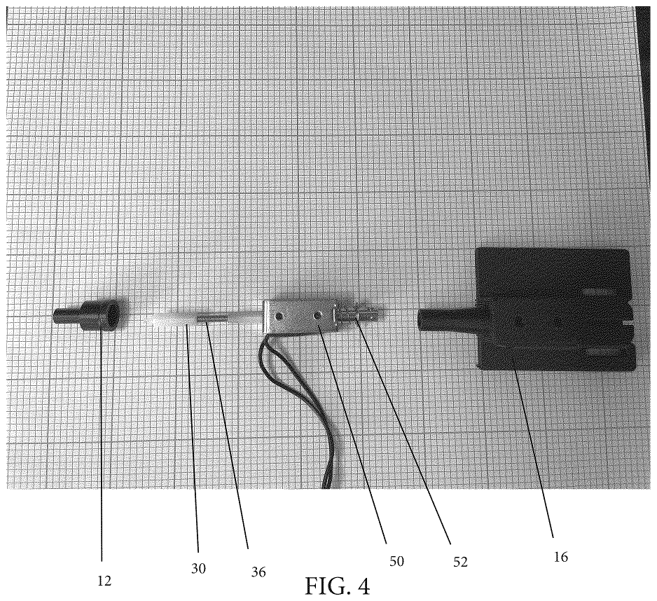

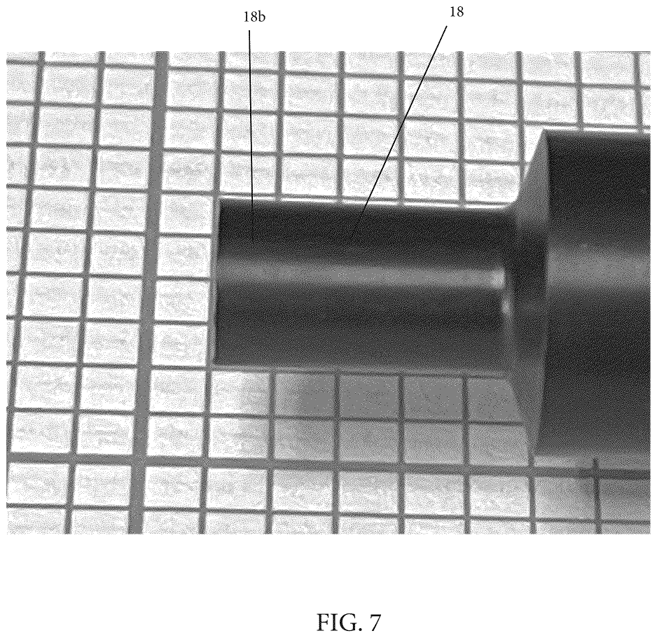

With specific reference to FIGS. 1 and 4, an electromagnetically actuated solenoid 50 is retained within the support housing 16 and is connected to the inner bead picker tip 30, and thus is also connected to the probe 40. The solenoid 50 is alternately energized to thereby effect the reciprocal motion of the inner bead picker tip 30. A spring 52 restores the probe 40 to the original position. As depicted in FIGS. 7, 8, 9, 10A, and 10B, the solenoid 50 is thus configured to selectively extend the probe 40 into the well 20 to enable the beads 20 to rest upon the rim 46, and to subsequently retract the probe 40 and the beads 22 (FIG. 10C) upward into the interior cavity of the bell 18b, for extracting the bell 18, the probe 40, and the beads 22 from the well 20. It is contemplated that the probe 40 can be retracted when the solenoid 50 is not energized and extended when the solenoid 50 is energized. Alternatively, the probe 40 can be extended when the solenoid 50 is not energized and retracted when the solenoid 50 is energized.

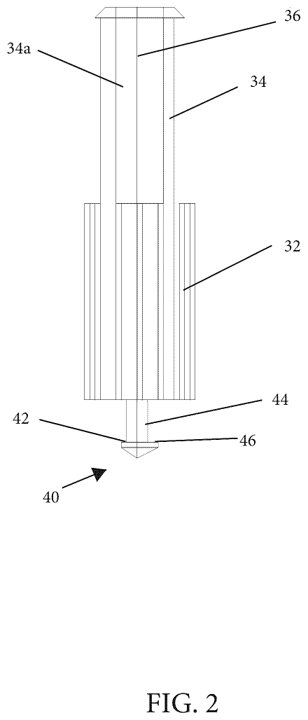

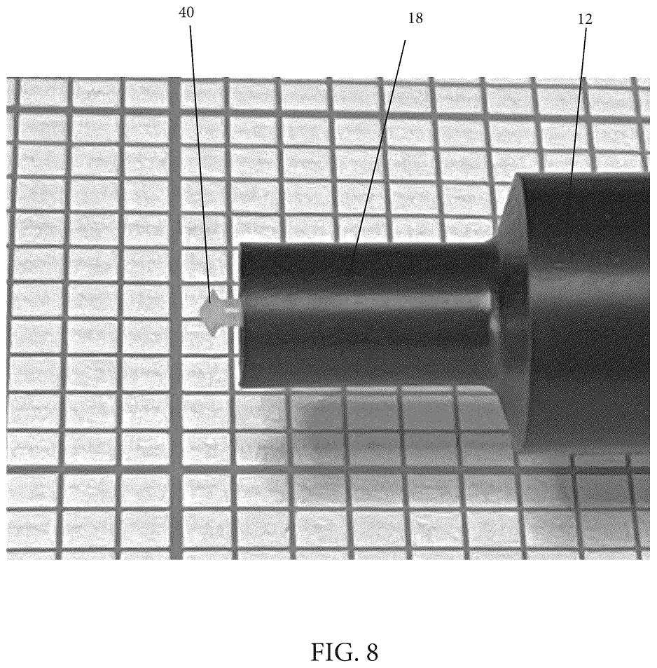

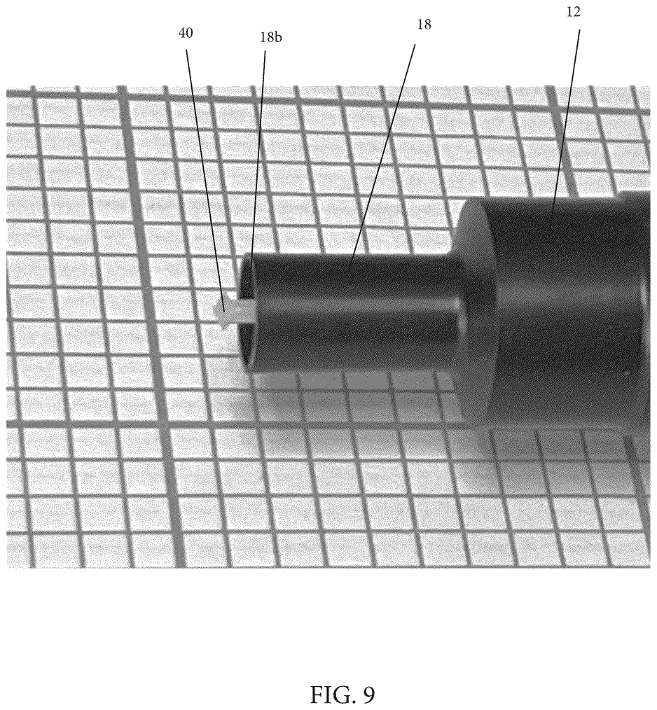

As evident from FIGS. 1, 2, 8, and 9, the head 42 of the probe 40 is preferably “top-shaped,” generally conical. As shown in FIGS. 1 and 2 the rim 46 is configured to be flat, as a type of shelf. As shown in FIGS. 8 and 9, the rim 46 can be configured to have a curved profile corresponding to a shape of the beads 22, to facilitate resting of the beads 22 on the rim 46. As shown in FIGS. 10A, 10B, and 10C, three beads 22 are provided in a circumferential configuration around the stem 42. The inner diameter of the bell 18b is sized to receive and accommodate the width of the three beads 22 having 2 mm diameters in the circumferential configuration as shown. It is to be appreciated that any size sphere can be picked up by suitably by adjusting the inner diameter of the bell 18b.

With further reference to FIGS. 1, 2, 8, and 9, in a preferred embodiment, the cylindrical diameter of the hollow interior of the bell 18b is about 5 mm. The conical head 42 of the probe 40 is preferably about 2 mm in diameter with a height of about 1 mm. The stem 44 has a diameter of about 1 mm. In this manner, the 2 mm beads fit within the interior of the bell 18b. When the probe 40 is retracted, the 2 mm bottom of the conical head 42 allows an annular gap of about 1.5 mm which is too small to permit the beads 22 to drop down therebetween. In this manner, the beads 22 are securely retained during extraction from one well 20 and deposition into another well 22. It is to be appreciated that the size of the bead picker 10 can be scaled up and down in size to extract beads 22 (or other suitable objects) without departing from the invention.

With ongoing reference to FIGS. 1, 2, 8, and 9, the 1 mm height of the conical head 42 is half the height of the 2 mm beads. In this manner, the conical head 42 pushes beads 22 out of the way when the probe 42 is extended, thereby clearing a path but for the probe 40. The 1 mm height is still low enough to allow the beads 22 to roll back onto the rim 46. The bell 18b with the entire outer bead picker top 12 cylinder comes down forcing the beads 22 back toward the stem 46 in the center as they are captured inside the bell 18b. The probe 40 is then retracted and the beads 22 are contained within the bell 18b. In this manner, the present bead picker 10 picks up all three beads at once.

With additional reference to FIGS. 1, 2, 8, and 9, the angle of conical head 42 is a shallow angle such that the rim 46 is no more than half the annular gap, or 0.75 mm. The height of the head 42 is short so that the beads 22 are forced over the edge of the rim 46 during extension of the probe 40. The angle thereby causes the beads 22 to move away. The bell 18b comes down and thereby forces the beads 22 back toward the center. The head 42 is not taller than half the height of the diameter of the beads 22 to enable the beads 22 to roll onto the rim 46. The vertical travel of the probe 40 during extension is about 2.10 mm, slightly larger than the 2 mm diameter of the beads 22 so that the beads 22 have adequate clearance to enter the bell 18b.

As shown in FIG. 6, the present bead picker 10 is preferably used with an actuator 70 which moves the bead picker 10 with an X-Y movement so that beads 22 can be extracted from one well 20 and displaced by precise predetermined amount to be deposited into a different well 20, in order to implement the steps of washing and release as described hereinabove. The X-Y movement of the actuator 70 enables the bead picker 10 to hit the center of the well 20 each time. In this manner, the bead picker 10 can be used with wells of varying diameters, still maintaining high accuracy. The present bead picker 10 thereby removes the human error associated with prior art practices and improves accuracy.

Having described the bead picker apparatus, a method of extracting beads is now described with reference to FIGS. 6, 10A, 10B, and 10C. A well 20 or other such receptacle is provided retaining one or more beads 22. A bell 18b having a hollow interior cavity is downwardly extended into the receptacle 20 proximal to the beads 22. A probe 40 is extended outwardly from within the bell 18b into the receptacle 20, alongside the beads 22, so that the beads 22 rest atop a rim 46, which is an interior surface of the probe 40. Bell 18b comes down onto the beads 22 while the probe 40 is retracted to withdraw the bead 22 upward into the hollow cavity of the bell 18b. The bell 18b, the probe 40, and the beads 22 are then extracted from the receptacle 20.

With further reference to FIGS. 6, 10A, 10B, and 10C, a step is performed of downwardly extending the bell 18b, the probe 40, and the beads 22 into a different receptacle 20. The probe 40 is extended outwardly from the bell 18b into the different receptacle 20 to release the beads 22 and thereby deposit the beads 22 into the different receptacle 20. Additional steps can include washing the beads 22 or extracting a predetermined material such as the aforementioned cancer cells from the exterior surface of the beads 22 while in the different receptacle 20. Three beads 22 placed in a circumferential configuration around the probe 40 can be retracted into the bell 18b which has an inner diameter sized to receive and accommodate the width of the three beads 22 in the circumferential configuration.

With additional reference to FIGS. 6, 10A, 10B, and 10C, the probe 40 includes a head 42 connected to a stem 44 such that a diameter of the head 42 is greater than a diameter of the stem 44. A rim 46 of the head 42 circumferentially surrounds a junction with the stem 44, and the rim 46 includes the interior surface of the head 42 facing into the interior cavity of the bell 18b. The steps of extending and retracting the probe are performed using an electromagnetically actuated solenoid 50 connected to the probe 40 for effecting reciprocal motion of the probe 40.

Many methods have been proposed for the isolation of individual circulating tumor cells (CTCs) in the prior art.

The Indian patent application number 202241064961 dated 12 Nov. 2022 titled “Compositions and methods for selective capture, purification, release and isolation of single cells” discloses compositions useful to isolate marker cells for cancer at the single-cell level from heterogeneous biological and clinical blood samples and methods to capture and release intact circulating tumor cells (CTCs) and isolate the same as individual single cell from the blood samples of cancer patients. However, these are not amenable to isolate individual single cells from a large population of cancer patients.

The method for the isolation of individual single cells involves A) RBC lysis of blood samples and B) isolation of individual single cells. Each step is described below.

Part A: RBC lysis of blood sample

Step 1:10 ml blood sample containing a few drops of EDTA (for stabilization and avoiding coagulation of the blood sample) is received from the pathology lab. This is transferred to a 50 ml centrifuge tube.

Step 2: About 20 ml of RBC lysis solution is added to the centrifuge tube and incubated for 10 min at 25° C. on a rotary shaker. This step separates RBCs from the blood sample wherein RBCs remain suspended as small particles. The rotary shaker is operated at around 20-25 rpm.

Step 3: The centrifuge tube containing the lysed RBC solution is centrifuged at 500 X g for 5 min at 25° C. The supernatant (containing RBC particles) is discarded. The WBCs and CTCs remain at the bottom of the centrifuge in the form of a pellet.

Step 4: The cell pellet is resuspended in 1 ml of RBC lysis buffer in the centrifuge tube and incubated for 5 min at the room temperature (25° C.) and the tube is allowed to stand on the benchtop for 5 mins.

Step 5: The contents of the Centrifuge tube are centrifuged at 500 X g for 5 min at 25° C. The supernatant is discarded and the pellet containing WBCs and CTCs is recovered.

Step 6: The cell pellet is resuspended in 1 ml 1X PBS in a * ml Centrifuge tube and centrifuged at 500 X g for 5 min at 25° C. The supernatant is discarded.

Step 7: The cell pellet is resuspended in 1 ml 1X PBS in a * ml Centrifuge tube and the PBS solution containing WBCs and CTCs is transferred to a 1.5 ml microcentrifuge tube.

Step 8: The contents of the above microcentrifuge tube are centrifuged at 500 X g for 5 min at 25° C. and the supernatant is discarded.

Step 9: The pellet is resuspended into 100 μl staining solution and incubated for 60 min at 25° C. in a micro centrifuge tube, while shaking on a rotary shaker at 20 rpm. 100 μl staining solution is prepared by adding 0.5 μl anti-CD 45 antibody stock solution (0.1 mg/ml), 0.4 μl AO stock solution, 5.0 μl DAPI stock solution to 94.1 μl 1X sterile PBS pH 7.4. (Final concentration of dyes: 10 μg/ml DAPI, 40 μM AO, and 5 μg/ml anti-CD 45 antibody conjugated to Alexa fluor 555/568).

### Part B: Isolation of Single Cell

Step 10: Using the bead picker pick up a cleaned 2 mm dia glass bead GB1 from the reservoir containing a multitude of coated glass beads and place it in a 96 well plate in the well 1A. Repeat the operation twice and deposit three glass beads in the well 1A. This operation is repeated to place three coated glass beads in each of the well plates 2A, 3A. 4A, 5A, 6A, 7A and 8A

Step 11: Using a micro pipettor transfer 100 μl contents of the micro centrifuge tube and drop it in the well plate 1A. This operation is repeated to place 100 μl contents of the micro centrifuge tube and drop it in each of the well plates 2A, 3A. 4A, 5A, 6A, 7A and 8A.

Step 12: Shift the 96 well plate from the location it was earlier to the new location where the contents will be incubated.

Step 13: The 96-well plate is now incubated at 25° C. on a rocker shaker at 40 rpm for 20 min.

Step 14: Using the micro pipettor 200 μl of PBS each (composition) is added to wells 1B, 1C, 1D, 1E, 1F,, 2B, 2C, 2D,2E, 2F, 3B, 3C, 3D,3E, 3F, 4B, 4C, 4D,4E, 4F, 5B, 5C, 5D,5E, 5F, 6B, 6C, 6D,6E, 6F, 7B, 7C, 7D,7E, 7F, 8B, 8C, 8D,8E, 8F.

Step 15: Using the bead picker transfer 3 glass beads from well 1A to 1B containing 200 μl 1X PBS. from well 2A to 2B containing 200 μl 1X PBS from well 3A to 3B containing 200 μl 1X PBS from well 4A to 4B containing 200 μl 1X PBS from well 5A to 5B containing 200 μl 1X PBS from well 6A to 6B containing 200 μl 1X PBS from well 7A to 7B containing 200 μl 1X PBS from well 8A to 8B containing 200 μl 1X PBS and place on a rocker shaker platform for 1 min.

Step 16: Using the bead picker transfer 3 glass beads from well 1B to 1C containing 200 μl 1X PBS. from well 2B to 2C containing 200 μl 1X PBS from well 3B to 3C containing 200 μl 1X PBS from well 4B to 4C containing 200 μl 1X PBS from well 5B to 5C containing 200 μl 1X PBS from well 6B to 6C containing 200 μl 1X PBS rom well 7B to 7C containing 200 μl 1X PBS from well 8B to 8C containing 200 μl 1X PBS and place on a rocker shaker platform for 1 min.

Step 17: Using the bead picker transfer 3 glass beads from well 1C to 1D containing 200 μl 1X PBS. from well 2C to 2D containing 200 μl 1X PBS from well 3C to 3D containing 200 μl 1X PBS from well 4C to 4D containing 200 μl 1X PBS from well 5C to 5D containing 200 μl 1X PBS from well 6C to 6D containing 200 μl 1X PBS rom well 7C to 7D containing 200 μl 1X PBS from well 8C to 8D containing 200 μl 1X PBS and place on a rocker shaker platform for 1 min.

Step 18: Using the bead picker transfer 3 glass beads from well 1D to 1E containing 200 μl 1X PBS. from well 2D to 2E containing 200 μl 1X PBS from well 3D to 3E containing 200 μl 1X PBS from well 4D to 4E containing 200 μl 1X PBS from well 5D to 5E containing 200 μl 1X PBS from well 6D to 6E containing 200 μl 1X PBS rom well 7D to 7E containing 200 μl 1X PBS from well 8D to 8E containing 200 μl 1X PBS and place on a rocker shaker platform for 1 min.

Step 19: Using the bead picker transfer 3 glass beads from well 1E to 1F containing 200 μl 1X PBS. from well 2E to 2F containing 200 μl 1X PBS from well 3E to 3F containing 200 μl 1X PBS from well 4E to 4F containing 200 μl 1X PBS from well 5E to 5F containing 200 μl 1X PBS from well 6E to 6F containing 200 μl 1X PBS rom well 7E to 7F containing 200 μl 1X PBS from well 8E to 8F containing 200 μl 1X PBS and place on a rocker shaker platform for 1 min. (Describe how 15-19 steps are carried out)

Step 20: The 96 well plate is now moved from the shaker to a location whereby the image and the position of each glass bead in each well can be recorded either from the top of the well plate or from the bottom of the well plate.

Step 21: Record the images of glass beads in each well using a fluorescence microscope. This can be done from the bottom or top.

Step 22: Record the image of each glass bead in each well using a fluorescence microscope by adjusting magnification. This can be done from the bottom or top.

Step 23: Transfer 100 μl of release medium using a sucker pipette into well 1G, 2G,3G,4G, 5G, 6G , 7G and 8G.

Step 24: Using the bead picker transfer three glass beads each from 1F to 1G, 2F to 2G, 3F to 3G, 4F to 4G, 5F to 5G, 6F to 6G, 7F to 7G and 8F to 8G. Now shift the 96 well plate to a shaker and incubate the plate at 37° C. in CO2 incubator for 20 min.

Step 25: Shift the 96 well-plate on a rocker shaker maintained at 25° C. and operated at 40 rpm for 1 min.

Step 26: Using the bead picker transfer three glass beads from 1G to 1H, 2G to 2H, 3G to 3H, 4G to 4H, 5G to 5H, 6G to 6H, 7G to 7H, 8G to 8H.

Step 27: Confirm the position of the released single CTCs in each well containing release buffer by automated imaging using a fluorescence microscope.

Step 28: Collect manually each individual released single CTC in 1.6 μl release buffer using 2.0 μl micro-pipette, while visualizing (AO or DAPI signal) with a microscope and transfer the single CTC into a 0.2 ml PCR tube. Add 0.4 μl storage solution in it.

Alternatively collect automatically each individual released single CTC using a micromanipulator.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

What is claimed:

1. An extraction device, comprising:
a bell having a hollow interior cavity, wherein the bell is configured to extend downwardly into a receptacle that receives and retains at least one bead;
a probe retained within the bell and configured for reciprocal motion to extend into and retract out of the receptacle;
a head of the probe connected to a stem of the probe such that a diameter of the head is greater than a diameter of the stem;
a rim of the head circumferentially surrounding a junction with the stem and defining an interior surface of the head facing into the interior cavity of the bell;
wherein the probe is configured for extending into the receptacle to enable the at least one bead to rest upon the rim; and
wherein the probe is configured for retracting to withdraw the at least one bead upward into the interior cavity of the bell, for extracting the bell and the at least one bead from the receptacle.

2. The extraction device of claim 1, wherein the bell is a component of an outer bead picker tip and the probe is a component of an inner bead picker tip.

3. The extraction device of claim 2, wherein the inner bead picker tip is received and retained within the outer bead picker tip.

4. The extraction device of claim 3, wherein the outer bead picker tip comprises a cap having an aperture for connecting to a support housing, and a body comprising the bell such that the interior cavity comprises a central bore with an axis for coaxially receiving and retaining the inner bead picker tip.

5. The extraction device of claim 4, wherein the body of the outer bead picker is cylindrical having an outer diameter sized to fit within a diameter of a cylindrical receptacle.

6. The extraction device of claim 1, further comprising an electromagnetically actuated solenoid connected to the probe for effecting the reciprocal motion of selectively extending and retracting the probe.

7. The extraction device of claim 1, wherein the head of the probe is generally conical and wherein the rim is configured to have a curved profile corresponding to a shape of the at least one bead, to facilitate resting of the at least one bead on the rim.

8. The extraction device of claim 1, wherein the at least one bead comprises three beads in a circumferential configuration around the stem, wherein an inner diameter of the bell is sized to receive and accommodate a width of the three beads in the circumferential configuration.

9. A bead picker, comprising:
an outer bead picker tip having a proximal end and a distal end, further comprising a cap at the proximal end for connecting to a support housing and a body having a central bore, wherein the body defines a bell at the distal end and the central bore comprises a hollow interior cavity of the bell, wherein the outer bead picker tip is configured to extend the bell downwardly into a receptacle that receives and retains at least one bead;
an inner bead picker tip retained within the central bore of the outer bead picker tip, wherein the inner bead picker tip comprises a probe retained within the bell and configured for reciprocal motion to extend into and retract out of the receptacle;
a head of the probe connected to a stem of the probe such that a diameter of the head is greater than a diameter of the stem;
a rim of the head circumferentially surrounding a junction with the stem and defining an interior surface of the head facing into the interior cavity of the bell; and
an electromagnetically actuated solenoid retained within the support housing and connected to the inner bead picker tip probe for effecting the reciprocal motion of the inner bead picker tip;
wherein the solenoid is configured to selectively extend the probe into the receptacle to enable the at least one bead to rest upon the rim, and to subsequently retract the probe and the at least one bead upward into the interior cavity of the bell, for extracting the bell and the at least one bead from the receptacle.

10. The bead picker of claim 9, wherein the body of the outer bead picker is cylindrical having an outer diameter sized to fit within a diameter of a cylindrical receptacle.

11. The bead picker of claim 9, wherein the head of the probe is generally conical and wherein the rim is configured to have a curved profile corresponding to a shape of the at least one bead, to facilitate resting of the at least one bead on the rim.

12. The bead picker of claim 9, wherein the at least one bead comprises three beads in a circumferential configuration around the stem, wherein an inner diameter of the bell is sized to receive and accommodate a width of the three beads in the circumferential configuration.

13. A method of extracting beads, comprising steps of:
providing a receptacle retaining at least one bead;
downwardly extending a bell having a hollow interior cavity into the receptacle proximal to the at least one bead;
extending a probe outwardly from within the bell into the receptacle, alongside the at least one bead, so that the at least one bead rests atop an interior surface of the probe;
extending the bell further into the receptacle to encircle the at least one bead;
retracting the probe to withdraw the at least one bead upward into the hollow cavity of the bell; and
extracting the bell, the probe, and the at least one bead from the receptacle.

14. The method of claim 13, further comprising steps of downwardly extending the bell, the probe, and the at least one bead into a different receptacle, and extending the probe outwardly from the bell into the different receptacle to release the at least one bead and thereby depositing the at least one bead into the different receptacle.

15. The method of claim 14, further comprising a step of washing the at least one bead or extracting a predetermined material from an exterior surface of the at least one bead while in the different receptacle.

16. The method of claim 13, further comprising retracting three beads in a circumferential configuration around the probe into the bell having an inner diameter sized to receive and accommodate a width of the three beads in the circumferential configuration.

17. The method of claim 13, wherein the probe comprises a head connected to a stem such that a diameter of the head is greater than a diameter of the stem, and wherein a rim of the head circumferentially surrounds a junction with the stem, wherein the rim comprises the interior surface of the head facing into the interior cavity of the bell.

18. The method of claim 13, wherein the steps of extending and retracting the probe are performed using an electromagnetically actuated solenoid connected to the probe for effecting reciprocal motion of the probe.

19. A method of extracting circulating tumor cells (CTCs) from a blood sample, comprising steps of:
providing a blood sample containing red blood cells (RBCs), white blood cells (WBCs) and CTCs in a centrifuge tube;
adding a lysis solution to the tube for suspending the RBCs as particles in the solution and discarding the lysis solution with the RBCs;
adding a PBS solution to the tube for suspending the WBCs and CTCs as particles in the solution;
transferring the PBS solution with the WBCs and CTCs to a receptacle containing a plurality of glass beads, wherein the glass beads include a coating for adhering the CTCs to the beads;
performing an extraction operation to remove the coated beads from the receptacle, wherein the extraction operation comprises steps of:
providing a receptacle retaining the plurality of beads;
downwardly extending a bell having a hollow interior cavity into the receptacle proximal to the beads;
extending a probe outwardly from within the bell into the receptacle, alongside the beads, so that the beads rest atop an interior surface of the probe;
extending the bell further into the receptacle to encircle the beads;
retracting the probe to withdraw the bead upwards into the hollow cavity of the bell; and
extracting the bell, the probe, and the beads from the receptacle;
wherein the method further comprises:
transfer the beads to a second receptacle containing a release medium for releasing the CTCs from the glass beads; and
collect at least one CTC from the release medium.
